(19) United States
(12) Patent Application Publication
(10) Pub. No.: US 2008/0055779 A1
(43) Pub. Date: Mar. 6, 2008

(54) Head slider having air guiding surface on side rail

(75) Inventor: Nobuhiko Ishihara, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/700,573

(22) Filed: Jan. 31, 2007

(30) Foreign Application Priority Data
Aug. 29, 2006 (JP) 2006-232866

(51) Int. Cl. G11B 5/60

(52) U.S. Cl. 360/235.4

(57) ABSTRACT

A head slider includes a front rail and a pair of rear side rails. Side rails extend from the outflow end of the front rail toward the rear side rails, respectively. Air guiding surfaces are defined within the outward surfaces of the side rails. The air guiding surfaces get far from the corresponding side edges, respectively, at a position closer to the outflow end of the slider body. A so-called yaw angle is defined in the head slider. Change in the yaw angle leads to change in the incident angle of airflow. Airflow runs across the side edge of the slider body. The airflow runs along the outward surface of the side rail. The airflow is received on the rear side rail. A predetermined positive pressure is generated at the rear side rail. The balance of the positive pressure enables a reduction in the roll angle.

### BACKGROUND OF THE INVENTION

1. Field of the Invention

The present invention relates to a head slider incorporated in a storage medium drive such as a hard disk drive, HDD.

2. Description of the Prior Art

A head slider is incorporated in hard disk drive, for example. Front and rear rails are defined on the bottom surface of the head slider. An electromagnetic transducer is embedded in the rear rail. The rear rail is defined on the longitudinal centerline of the head slider. When a magnetic recording disk rotates, the head slider is allowed to fly above the surface of the rotating magnetic disk based on the airflow generated along the rotating magnetic recording disk.

The head slider suffers from a change in a so-called roll angle. The term “roll angle” is used to define an inclined angle in the lateral direction of the head slider perpendicular to the direction of the airflow. When the roll angle increases, the outflow corner of the head slider gets closer to the rotating magnetic recording disk than the electromagnetic transducer does. Accordingly, the flying height of the electromagnetic transducer cannot be reduced enough. The HDD suffers from a reduction in the recording density.

### SUMMARY OF THE INVENTION

It is accordingly an object of the present invention to provide a head slider capable of reducing a change in a roll angle.

According to the present invention, there is provided a head slider comprising: a slider body having a bottom surface; a front rail defined on the bottom surface near an inflow end of the slider body; a pair of rear side rails defined on the bottom surface near an outflow end of the slider body; side rails extending on the bottom surface from an outflow end of the front rail toward the rear side rails, respectively, the side rails being terminated at positions spaced upstream from the rear side rails, respectively; and air guiding surfaces defined within outward surfaces of the side rails, the air guiding surfaces getting far from corresponding side edges of the slider body, respectively, at a position closer to the outflow end of the slider body.

The head slider enables the air guiding surface defined in the outward surface of the side rail. The outward surface gets far from the side edge of the slider body at a position closer to the outflow end. A so-called yaw angle is defined in the head slider. Change in the yaw angle leads to change in the incident angle of airflow. Airflow runs across the side edge of the slider body. The airflow runs along the outward surface of the side rail. The airflow is received on the rear side rail. A predetermined positive pressure is generated at the rear side rail. The balance of the positive pressure enables a reduction in the roll angle.

The head slider may further comprise: a front air bearing surface defined on the top surface of the front rail, the front air bearing surface having the inflow end at least partly contoured along a predetermined arc; and a low level surface defined at the inflow end of the front rail, the low level surface being connected to the front air bearing surface through a step, the low level surface extending at a level lower than that of the front air bearing surface. In this case, the contour of the inflow end of the front air bearing surface may include an arc section contoured along a predetermined arc.

The head slider enables the inflow end of the front air bearing surface having the contour including the arc section. Change in the yaw angle leads to change in the incident angle of airflow as described above. Airflow is thus allowed to run in the direction normal to the arc defining the arc section, for example. The front air bearing surface is thus allowed to enjoy establishment of a predetermined positive pressure. The balance of the positive pressure enables a reduced roll angle.

The air guiding surface may be a flat surface in the head slider. The inflow end of the front rail may be flush with the inflow end of the slider body. The head slider may be utilized in a storage medium drive.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a storage medium drive according to the present invention;

FIG. 2 is a perspective view schematically illustrating a flying head slider according to a first embodiment of the present invention;

FIG. 3 is a plan view schematically illustrating the flying head slider;

FIG. 4 is a graph showing the influence of side rail on the roll angle of the flying head slider;

FIG. 5 is a plan view schematically illustrating a flying head slider according to a second embodiment of the present invention;

FIG. 6 is a graph showing the influence of side rails and the contour of a front air bearing surface on the roll angle of the flying head slider;

FIG. 7 is a graph showing the influence of the radius of curvature of an arc section on the roll angle of the flying head slider;

FIG. 8 is a plan view schematically illustrating a flying head slider according to a third embodiment of the present invention;

FIG. 9 is a plan view schematically illustrating a flying head slider according to a fourth embodiment of the present invention;

FIG. 10 is a plan view schematically illustrating a flying head slider according to a fifth embodiment of the present invention;

FIG. 11 is a graph showing the influence of side rails and the contour of a front air bearing surface on the roll angle of the flying head slider;

FIG. 12 is a plan view schematically illustrating a flying head slider according to a sixth embodiment of the present invention; and

FIG. 13 is a graph showing the influence of the shape of side rails on the roll angle of the flying head slider.

### DESCRIPTION OF THE PREFERRED EMBODIMENTS

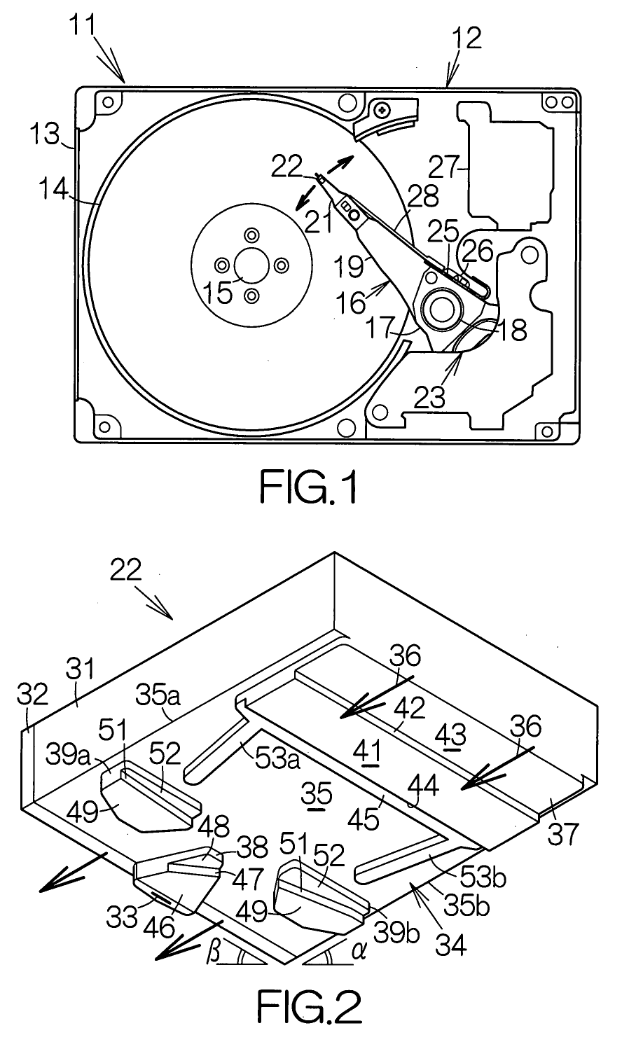

FIG. 1 schematically illustrates the structure of a hard disk drive, HDD, 11 as an example of a storage medium drive or a storage device according to the present invention. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the base 13. The cover serves to close the opening of the inner space within the base 13. Pressing process may be employed to form the cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process maybe employed to form the carriage block 17, for example.

A head suspension 21 is attached to the front or tip end of the individual carriage arm 19. The head suspension 21 is designed to extend forward from the carriage arm 19. A so-called gimbal spring, not shown, is connected to the tip end of the individual head suspension 21. A flying head slider 22 is fixed to the surface of the gimbal spring. The gimbal spring allows the flying head slider 22 to change its attitude relative to the head suspension 21. A head element or electromagnetic transducer is mounted on the flying head slider 22 as described later.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 swings around the vertical support shaft 18 during the flight of the flying head slider 22, the flying head slider 22 is allowed to move along the radial direction of the magnetic recording disk 14. The electromagnetic transducer on the flying head slider 22 is allowed to cross the data zone defined between the innermost and outermost recording tracks. The electromagnetic transducer on the flying head slider 22 can thus be positioned right above a target recording track on the magnetic recording disk 14.

A power source such as a voice coil motor, VCM, 23 is connected to the carriage block 17. The voice coil motor 23 serves to drive the carriage block 17 around the vertical support shaft 18. The rotation of the carriage block 17 allows the carriage arms 19 and the head suspensions 21 to swing.

As is apparent from FIG. 1, a flexible printed wiring board 25 is located on the carriage block 17. A head IC (integrated circuit) 26 is mounted on the flexible printed wiring board 25. The head IC 26 is designed to supply the read element of the electromagnetic transducer with a sensing current when the magnetic bit data is to be read. The head IC 26 is also designed to supply the write element of the electromagnetic transducer with a writing current when the magnetic bit data is to be written. A small-sized circuit board 27 is located within the inner space of the enclosure 12. A printed wiring board, not shown, is attached to the outward surface of the bottom plate of the base 13. The small-sized circuit board 27 and the printed wiring board on the bottom plate are designed to supply the head IC 26 with the sensing current and the writing current.

A flexure 28 is utilized to supply the sensing current and the writing current. A flexible printed wiring board is formed on the flexure 28. The flexure 28 is related to the individual flying head slider 22. The flexure 28 is made of a metallic thin plate such as a stainless steel plate. The flexible printed wiring board may include an insulating layer, an electrically-conductive layer and a protection layer, which are overlaid on the flexure 28 in this sequence. The flexible printed wiring board provides a wiring pattern extending on the flexure 28. The electrically conductive layer may be made of an electrically-conductive material such as copper. The insulating layer and the protection layer may be made of a resin material such as polyimide resin.

The flying head slider 22 is supported on one end or the front end of the flexure 28. The flexible printed wiring board on the flexure 28 is connected to the flying head slider 22. Spot welding may be employed to fix the flexure 28 on the head suspension 21, for example. The flexure 28 is designed to extend backward from the head suspension 21 along the carriage arm 19. The other end or rear end of the flexure 28 is coupled to the flexible printed wiring board 25. The flexible printed wiring board on the flexure 28 is connected to a wiring pattern, not shown, formed on the flexible printed wiring board 25. Electric connection is in this manner established between the flying head slider 22 and the flexible printed wiring board 25.

FIG. 2 illustrates a flying head slider 22 according to a first embodiment of the present invention. The flying head slider 22 includes a slider body 31 in the form of a flat parallelepiped, for example. A head protection film 32 is overlaid on the outflow or trailing end of the slider body 31. The aforementioned electromagnetic transducer, namely an electromagnetic transducer 33, is incorporated in the head protection film 32. The flying head slider 22 maybe a so-called FEMTO slider. The longitudinal length of the flying head slider 22 is set at approximately 0.85 mm, for example. The lateral length of the flying head slider 22 is set at approximately 0.70 mm, for example. The thickness of the flying head slider 22 may be set at approximately 0.23 mm, for example.

The slider body 31 may be made of a hard material such as Al₂O₃-Tic. The head protection film 32 is made of a soft material such as Al₂O₃ (alumina). A medium-opposed surface or bottom surface 34 is defined over the slider body 31 so as to face the magnetic recording disk 14 at a distance. A flat base surface 35 as a reference surface is defined in the bottom surface 34. When the magnetic recording disk 14 rotates, airflow 36 flows along the bottom surface 34 from the inflow or front end toward the outflow or rear end of the slider body 31.

A front rail 37 is formed in the bottom surface 34 of the slider body 31. The front rail 37 stands upright from the base surface 35 of the bottom surface 34 near the inflow end of the slider body 31. The front rail 37 is designed to extend in the lateral direction of the slider body 31 along the inflow end of the base surface 35. The thickness of the front rail 37 is set in a range between 1.5 μm and 2.0 μm approximately on the base surface 35, for example. The inflow end of the front rail 37 is set flush with the inflow end of the slider body 31. Specifically, the inflow ends of the front rail 37 and the slider body 31 are defined within a plane.

A rear rail 38 is likewise formed in the bottom surface 34 of the slider body 31. The rear rail 38 stands upright from the base surface 35 of the bottom surface 34 near the outflow end of the slider body 31. The rear rail 38 is located at the middle position in the lateral direction of the slider body 31. The rear rail 38 is designed to extend toward the outflow end of the base surface 35. The thickness of the rear rail 38 on the base surface 35 is set equal to that of the front rail 37.

A pair of rear side rails or auxiliary rear rails 39a, 39b are likewise formed in the bottom surface 34 of the slider body 31. The auxiliary rear rails 39a, 39b stand upright from the base surface 35 of the bottom surface 34 near the outflow end of the slider body 31. The auxiliary rear rails 39a, 39b are located adjacent to the side edges 35a, 35b of the base surface 35, respectively. The auxiliary rear rails 39a, 39b are thus distanced from each other in the lateral direction of the slider body 31. The rear rail 38 is located in a space between the auxiliary rear rails 39a, 39b. It should be noted that the side edge 35a corresponds to the edge closer to the rotation axis of the magnetic recording disk 14, while the side edge 35b corresponds to the edge closer to the outer periphery of the magnetic recording disk 14.

A front air bearing surface 41 is defined on the top surface of the front rail 37. A step 42 is formed at the inflow end of the front air bearing surface 41. A low level surface 43 is defined on the top surface of the front rail 37 at a position upstream of the front air bearing surface 41. The low level surface 43 extends at a level lower than that of the front air bearing surface 41.

A step 44 is formed at the outflow end of the front air bearing surface 41. A low level surface 45 is defined on the top surface of the front rail 37 at a position downstream of the front air bearing surface 41. The low level surfaces 43, 45 extend at an identical level. The longitudinal length of the low level surface 45 in the longitudinal direction of the flying head slider 22 is set smaller than that of the low level surface 43. The width of the low level surface 45 in the lateral direction of the flying head slider 22 is set equal to that of the low level surface 43.

A rear air bearing surface 46 is likewise defined on the top surface of the rear rail 38. A step 47 is formed at the inflow end of the rear air bearing surface 46. A low level surface 48 is defined on the top surface of the rear rail 38 at a position upstream of the rear air bearing surface 46. The low level surface 48 extends at a level lower than that of the rear air bearing surface 46.

An auxiliary air bearing surface 49 is likewise defined on the top surface of each of the auxiliary rear rails 39a, 39b. The auxiliary air bearing surfaces 49 are located along the side edges 35a, 35b of the base surface 35, respectively. The auxiliary air bearing surfaces 49 are thus spaced from each other in the lateral direction of the slider body 31. The rear air bearing surface 46 is located between the auxiliary air bearing surfaces 49. A step 51 is formed at the inflow end of the individual auxiliary air bearing surface 49. A low level surface 52 is defined on the top surface of each of the auxiliary rear rails 39a, 39b at a position upstream of the auxiliary air bearing surface 49. The low level surface 52 extends at a level lower than that of the auxiliary air bearing surface 49.

The aforementioned electromagnetic transducer 33 is embedded in the rear rail 38. The electromagnetic transducer 33 includes a read element and a write element. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example. The write element may include a thin film magnetic head designed to write magnetic bit data into the magnetic recording disk 14 by utilizing a magnetic field induced at a thin film coil pattern. The read gap and the write gap of the electromagnetic transducer 33 are exposed at a position downstream of the rear air bearing surface 46.

A protection film, not shown, is formed on the surface of the slider body 31 at the air bearing surfaces 41, 46, 49, for example. The protection film extends over the read gap and the write gap on the rear air bearing surface 46. The protection film may be made of diamond-like-carbon (DLC), for example.

The bottom surface 34 of the flying head slider 22 is designed to receive the airflow 36 generated along the rotating magnetic recording disk 14. The steps 42, 47, 51 serve to generate a larger positive pressure or lift at the air bearing surfaces 41, 46, 49, respectively. Moreover, a larger negative pressure is induced behind or downstream of the front rail 37. The negative pressure is balanced with the lift so as to stably establish the flying attitude of the flying head slider 22.

A larger positive pressure or lift is generated at the front air bearing surface 41 as compared with the rear and auxiliary air bearing surfaces 46, 49 in the flying head slider 22. When the slider body 31 flies above the surface of the magnetic recording disk 14, the slider body 31 can be kept at an inclined attitude defined by a pitch angle α. The term “pitch angle” is used to define the inclined angle in the longitudinal direction of the slider body 31 along the direction of the airflow 36.

A lift is equally generated at the pair of auxiliary air bearing surfaces 49, 49. This results in suppression of change in the roll angle β of the flying head slider 22 during flight. The auxiliary air bearing surfaces 49, 49 are in this manner prevented from colliding or contacting against the magnetic recording disk 14. The term “roll angle” is used to define the inclined angle in the lateral direction of the slider body 31 perpendicular to the direction of the airflow 36.

A pair of side rails 53a, 53b are also formed on the bottom surface 34 of the slider body 31. The side rails 53a, 53b stand upright from the base surface 35 near the outflow end of the front rail 37. The side rails 53a, 53b are terminated at a position spaced from the corresponding auxiliary rear rails 39a, 39b. The inflow ends of the side rails 53a, 53b are connected to the outflow end surface of the front rail 37 at the opposite ends of the front rail 37 in the lateral direction, respectively. Each of the side rails 53a, 53b defines the top surface extending at the level equal to that of the low level surfaces 43, 45 of the front rail 37. The top surfaces of the side rails 53a, 53b thus extend at a level lower than that of the front air bearing surface 41.

The side rails 53a, 53b serve to prevent airflow from running into a space behind the front rail 37 around the opposite ends of the front rail 37 in the lateral direction during the flight of the flying head slider 22. The airflow 36 is thus allowed to expand in the direction perpendicular to the base surface 35 of the bottom surface 34 right after the airflow 36 has passed the front air bearing surface 41. The expansion of the airflow in this manner contributes to establishment of the negative pressure.

As shown in FIG. 3, each of the side rails 53a, 53b defines an outward surface 54 standing upright from the base surface 35 and an inward surface 55 standing upright from the base surface 35. The top ends of the outward and inward surfaces 54, 55 are connected to the top surface of the side rails 53a, 53b. The inward surfaces 55, 55 of the side rails 53a, 53b are opposed to each other. The inward and outward surfaces 54, 55 gets farther from the side edges 35a, 35b of the base surface 35 at positions closer to the inflow end. Specifically, the outward and inward surfaces 54, 55 are designed to incline inward. In this case, the outward surface 54 is set parallel to the inward surface 55 on each of the side rails 53a, 53b.

The intersection angle may be set equal to or larger than 2 or 3 degrees between the outward surface 54 and a plane parallel to the side surface of the slider body 31, for example. Here, the intersection angle is set at 5 degrees between the outward surface 54 of the side rail 53a and the plane, for example. The intersection angle is set at 12 degrees between the outward surface 54 of the side rail 53b and the plane, for example. Since the inward surface 55 is set parallel to the outward surface 54 in each of the side rails 53a, 53b, the intersection angle for the inward surfaces 55, 55 is equal to the intersection angle for the corresponding outward surfaces 54, 54.

A so-called yaw angle is defined between the recording track of the magnetic recording disk 14 and the longitudinal centerline 56 of the flying head slider 22 during the flight of the flying head slider 22. Change in the yaw angle leads to change in the incident angle of airflow. Airflow thus runs across the side edge 35a or 35b. The airflow runs along the outward surface 54. The outward surface 54 serves as air guiding surfaces in this manner. The guided airflow is received on the auxiliary rear rail 39a or 39b. This results in generation of a positive pressure at the auxiliary air bearing surface 49. The balance of the positive pressure serves to reduce the roll angle β toward zero. The flying height of the electromagnetic transducer 33 can thus be set lower.

The inventor has observed the influence of the side rails 53a, 53b. A computer simulation was employed for the observation. A specific example No. 1 reflected the aforementioned flying head slider 22. A comparative example was also prepared. The side rails were designed to extend in parallel with the side edges of the base surface from the front rail toward the auxiliary rear rails in a flying head slider of the comparative example. The outward and inward surfaces were set parallel to the side edges of the base surface. Otherwise, the comparative example had the structure identical to that of the specific example No. 1.

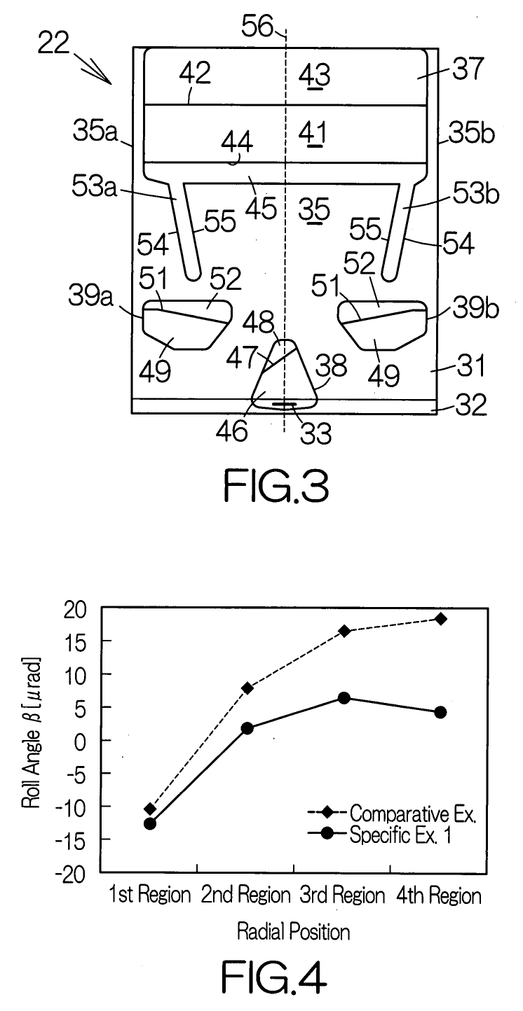

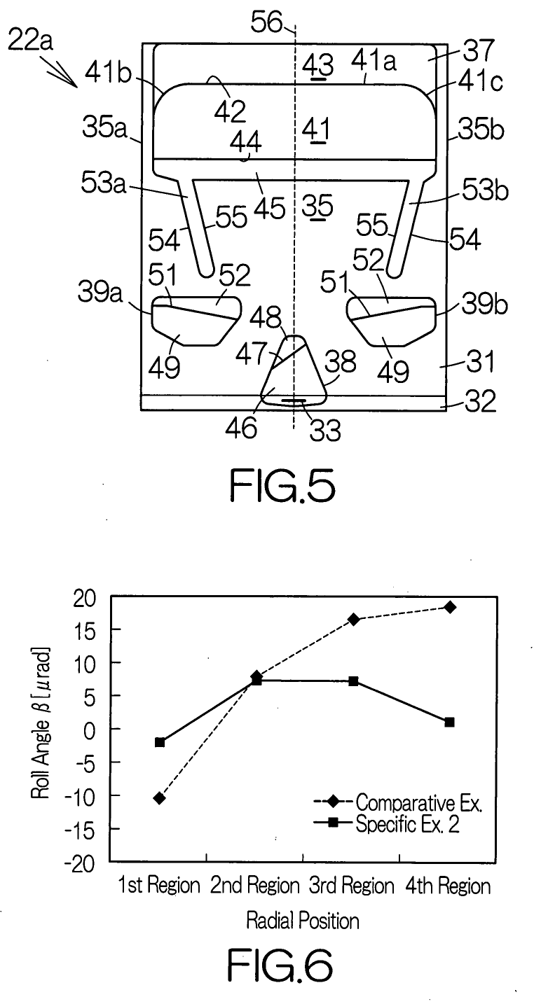

As is apparent from FIG. 4, it has been confirmed that the roll angle β gets closer to zero in the second, third and fourth regions of the magnetic recording disk 14 in the radial direction of the magnetic recording disk 14, namely at positions near the outer periphery of the magnetic recording disk 14 in the specific example No. 1, as compared with the comparative example. Moreover, change in the roll angle β was significantly suppressed within the second, third and fourth regions in the specific example No. 1 as compared with the comparative example. Here, negative roll angles β correspond to attitudes of the flying head slider allowing the side edge 35a closer to the center of the magnetic recording disk 14 to approach the magnetic recording disk 14. Positive roll angle β correspond to attitudes of the flying head slider allowing the side edge 35b closer to the outer periphery of the magnetic recording disk 14 to approach the magnetic recording disk 14.

FIG. 5 illustrates a flying head slider 22a according to a second embodiment of the present invention. The contour of the inflow end of the front air bearing surface 41 includes a straight section 41a and a pair of arc sections 41b, 41c connected to the opposite ends of the straight section 41a, respectively, in the flying head slider 22a. Each of the arc sections 41b, 41c is defined along a predetermined arc. The predetermined arc may have the center of curvature on the front air bearing surface 41. The straight section 41a is set parallel to the inflow end of the slider body 31. The arc sections 41b, 41c may have the radius of curvature equal to or larger than 0.07 mm, for example. Like reference numerals are attached to structure or components equivalent to those of the aforementioned flying head slider 22.

Change in the yaw angle leads to change in the incident angle of airflow in the flying head slider 22a. Establishment of a predetermined yaw angle enables airflow to run at the arc section 41b in the direction normal to the predetermined arc. Establishment of the predetermined yaw angle likewise enables airflow to run at the arc section 41c in a direction perpendicular to a tangent to the predetermined arc. This results in a reliable establishment of a predetermined positive pressure at the front air bearing surface 41. The balance of the positive pressure serves to reduce the roll angled β toward zero. The flying height of the electromagnetic transducer 33 can thus be set lower.

The inventor has observed the influence of the side rails 53a, 53b, the straight section 41a and the arc sections 41b, 41c. A computer simulation was utilized for the observation. The aforementioned flying head slider of the comparative example was again utilized for the observation. As shown in FIG. 6, it has been confirmed that the roll angle β gets closer to zero at any position in the radial direction of the magnetic recording disk 14 in a specific example No. 2 of the flying head slider 22a as compared with the comparative example. Moreover, change in the roll angle β was significantly suppressed in the specific example No. 2 as compared with the comparative example.

Next, the inventor has observed the influence of the radius of curvature of the arc sections 41b, 41c. A computer simulation was utilized for the observation. The radius of curvature was set different for specific examples No. 3 to No. 7 of the flying head slider 22a. The radius of curvature was set at 0.01 mm in the specific example No. 3. The radius of curvature was set at 0.07 mm in the specific example No. 4. The radius of curvature was set at 0.10 mm in the specific example No. 5. The radius of curvature was set at 0.15 mm in the specific example No. 6. The radius of curvature was set at 0.17 mm in the specific example No. 7.

The side rails 53a, 53b were designed to extend in parallel with the side edges 35a, 35b from the front rail 37 toward the auxiliary rear rails 39a, 39b in the specific examples No. 3 to No. 7. The outward and inward surfaces 54, 55 were formed in parallel with the side edges 35a, 35b, respectively. The aforementioned flying head slider of the comparative example was again utilized for the observation. The inflow end of the front air bearing surface was set to have the contour parallel to the inflow end of the base surface. Otherwise, the comparative example had the structure identical to that of the specific example No. 2.

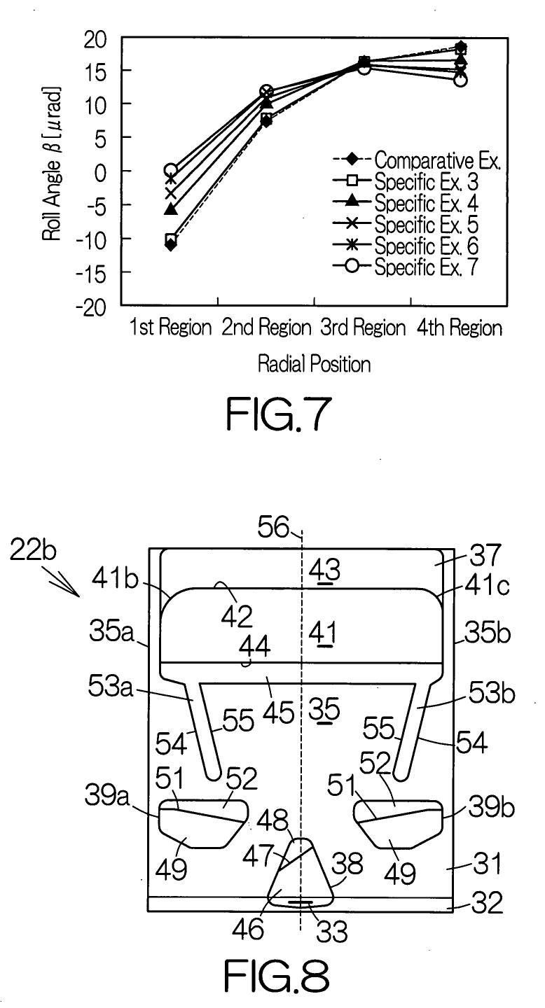

As shown in FIG. 7, it has been confirmed that the roll angle β gets closer to zero at the first, third and fourth regions of the magnetic recording disk 14 in the specific examples No. 3 to No. 7 as compared with the comparative example. The roll angle β got particularly close to zero at the first region nearest to the center of the magnetic recording disk 14. Moreover, when the arc sections 41b, 41c had a larger radius of curvature, the roll angle β got closer to zero. When the radius of curvature was set equal to or larger than 0.70 mm, for example, the roll angle β got much closer to zero.

In general, an arc section is defined at the corner of the inflow end of the front rail. Even when the front rail contacts or collides against the magnetic recording disk 14, the arc section serves to prevent damages to the front rail and the magnetic recording disk 14. In this case, the arc section has the radius of curvature set in a range from 0.01 mm to 0.02 mm, for example. Specifically, the arc sections 41b, 41c are discriminated from the conventional arc section.

FIG. 8 illustrates a flying head slider 22b according to a third embodiment of the present invention. The radius of curvature of the arc section 41b is set larger than that of the arc section 41c in the flying head slider 22b. The arc section 41b is located near the center of the magnetic recording disk 14. The arc section 41c is located near the outer periphery of the magnetic recording disk 14. Like reference numerals are attached to the structure or components equivalent to those of the aforementioned flying head slider 22a.

In general, airflow having a larger flow rate is generated at a position closer to the outer periphery of the magnetic recording disk 14. Accordingly, the arc sections 41b, 41c are exposed to airflow of different flow rates. Specifically, the arc section 41c near the outer periphery of the magnetic recording disk 14 receives airflow having a larger flow rate as compared with the arc section 41b near the center of the magnetic recording disk 14. The arc section 41b having a larger radius of curvature is allowed to receive airflow of a smaller flow rate by a sufficient amount. The arc section 41c having a smaller radius of curvature is allowed to receive airflow having a larger flow rate. The front air bearing surface 41 is in this manner allowed to enjoy a predetermined positive pressure. The balance of the positive pressure serves to reduce the roll angle β toward zero.

FIG. 9 illustrates a flying head slider 22c according to a fourth embodiment of the present invention. The contour of the outflow end of the front air bearing surface 41 includes a first straight section 41d, a pair of arc sections 41e, 41f connected to the opposite ends of the first straight section 41d, and second straight sections 41g, 41h respectively connected to the outer ends of the arc sections 41e, 41f. The first straight section 41d and the second straight sections 41g, 41h are set parallel to the aforementioned straight section 41a. The arc sections 41e, 41f are defined in a space inside the aforementioned arc sections 41b, 41c.

The arc sections 41e, 41f are defined in a space inside the arc sections 41b, 41c along arcs having the shape similar to that of the arcs defining the arc sections 41b, 41c. The front air bearing surface 41 and the arc sections 41e, 14f serve to make the length between the inflow end and the outflow end along the direction of airflow constant irrespective of the direction of the airflow. Like reference numerals are attached to the structure or components equivalent to those of the aforementioned flying head slider 22a.

The intersection angle gets larger between the centerline 56 and the incident angle of airflow at a position closer to the side edges 35a, 35b in the flying head slider 22c in the same manner as described above. The length of the front air bearing surface 41 is set constant between the inflow end and the outflow end along the direction of airflow. Airflow is allowed to pass across the front air bearing surface 41 by a constant distance at any position on the inflow end of the front air bearing surface 41. The front air bearing surface 41 is in this manner allowed to enjoy a predetermined positive pressure. The balance of the positive pressure serves to reduce the roll angle β toward zero.

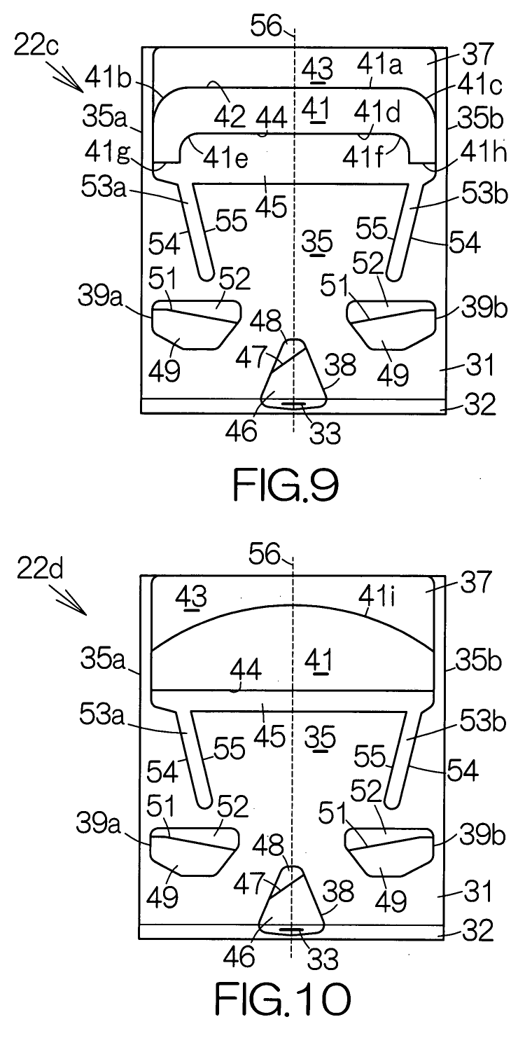

FIG. 10 illustrates a flying head slider 22d according to a fifth embodiment of the present invention. The contour of the inflow end of the front air bearing surface 41 includes an arc section 41i defined along a single arc. The center of curvature of the single arc is located at a position downstream of the arc section 41i. The single arc may have a predetermined radius of curvature depending upon the direction of airflow. The inflow end of the front air bearing surface 41 may get closest to the inflow end of the slider body 31 at the intersection between the single arc and the centerline 56. Like reference numerals are attached to the structure or components equivalent to those of the aforementioned flying head slider 22a.

The intersection angle gets larger between the centerline 56 and the incident angle of airflow at a position closer to the side edges 35a, 35b in the flying head slider 22d in the same manner as described above. The arc section 41i is defined along the single arc in the front air bearing surface 41. Air flow is thus allowed to always run across the inflow end of the front air bearing surface 41 in the direction normal to the single arc at any position on the inflow end of the front air bearing surface 41. The front air bearing surface 41 is in this manner allowed to enjoy a predetermined positive pressure. The balance of the positive pressure serves to reduce the roll angle β toward zero.

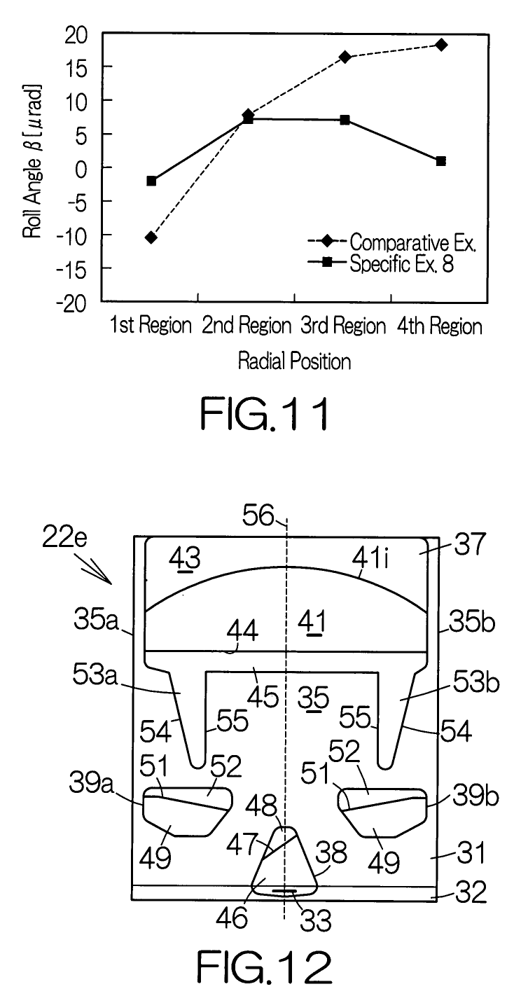

The inventor has observed the influence of the side rails 53a, 53b and the arc section 41i. A computer simulation was employed for the observation. The aforementioned flying head slider of the comparative example was again utilized for the observation. As shown in FIG. 11, it has been confirmed that the roll angle β gets closer to zero at any position on the radial direction of the magnetic recording disk 14 in a specific example No. 8 of the flying head slider 22d as compared with the comparative example. Moreover, change in the roll angle β was significantly suppressed in the specific example No. 8 as compared with the comparative example.

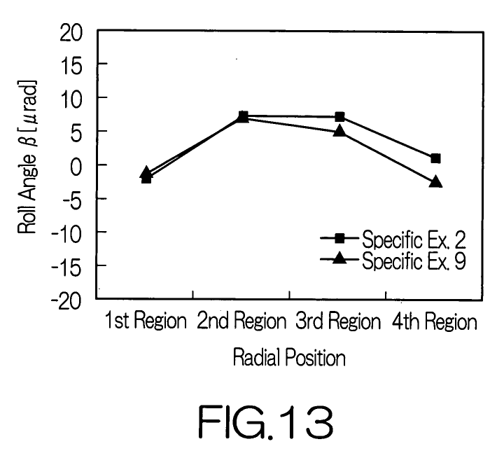

FIG. 12 illustrates a flying head slider 22e according to a sixth embodiment of the present invention. The inward surfaces 55, 55 of the side rails 53a, 53b are set parallel to the side edges 35a, 35b, for example, in the flying head slider 22e. The side rails 53a, 53b thus taper from the inflow end of the front rail 37 toward the auxiliary rear rails 39a, 39b. The outward surfaces 54 get farther from the side edges 35a, 35b at positions closer to the outflow end in the same manner as described above. Like reference numerals are attached to the structure or components equivalent to those of the aforementioned flying head slider 22d.

The inventor has observed the influence of the shape of the side rails 53a, 53b. A computer simulation was utilized for the observation. As shown in FIG. 13, it has been confirmed that the roll angle β gets closer to zero in a specific example No. 9 of the flying head slider 22e in the same manner as the specific example No. 8 of the flying head slider 22d. It has been confirmed that the roll angle β gets closer to zero regardless of the shape of the inward surfaces 55 of the side rails 53a, 53b. It has been confirmed that the outward surfaces 54 contribute to realization of this advantage.

The inward surfaces 55 of the side rails 53a, 53b may be set parallel to the side edges 35a, 35b in the aforementioned flying head sliders 22, 22a, 22b, 22c and 22d in the same manner as the flying head slider 22e. In other words, the side rails 53a, 53b may respectively taper toward the auxiliary rear rails 39a, 39b. Another type of head slider such as a so-called pico slider may be employed in the flying head sliders 22, 22a, 22b, 22c, 22d and 22e.

What is claimed is:

1. A head slider comprising:
a slider body having a bottom surface;
a front rail defined on the bottom surface near an inflow end of the slider body;
a pair of rear side rails defined on the bottom surface near an outflow end of the slider body;
side rails extending on the bottom surface from an outflow end of the front rail toward the rear side rails, respectively, said side rails being terminated at positions spaced upstream from the rear side rails, respectively; and
air guiding surfaces defined within outward surfaces of the side rails, said air guiding surfaces getting far from corresponding side edges of the slider body, respectively, at a position closer to the outflow end of the slider body.

2. The head slider according to claim 1, further comprising:
a front air bearing surface defined on a top surface of the front rail, the front air bearing surface having an inflow end at least partly contoured along a predetermined arc; and
a low level surface defined at an inflow end of the front rail, the low level surface being connected to the front air bearing surface through a step, said low level surface extending at a level lower than that of the front air bearing surface.

3. The head slider according to claim 1, wherein the air guiding surface is a flat surface.

4. The head slider according to claim 1, wherein the inflow end of the front rail is flush with the inflow end of the slider body.

5. A storage medium drive comprising:
a head slider including a slider body having a bottom surface;
a front rail defined on the bottom surface near an inflow end of the slider body;
a pair of rear side rails defined on the bottom surface near an outflow end of the slider body;
side rails extending on the bottom surface from an outflow end of the front rail toward the rear side rails, respectively, said side rails being terminated at positions spaced upstream from the rear side rails, respectively; and
air guiding surfaces defined within outward surfaces of the side rails, said air guiding surfaces getting far from corresponding side edges of the slider body, respectively, at a position closer to the outflow end of the slider body.
